(19) United States
(12) Patent Application Publication
(10) Pub. No.: US 2008/0317984 A1
(43) Pub. Date: Dec. 25, 2008

(54) Highly Crimped Conjugated Fiber Cheese Package and Process for Its Production

(76) Inventors: Akira Yamashita, Tokyo (JP); Tadashi Koyanagi, Tokyo (JP); Teruhiko Matsuo, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/090,456

(22) PCT Filed: Oct. 19, 2006
(86) PCT No.: PCT/JP2006/320863

§ 371 Date: Apr. 16, 2008

(30) Foreign Application Priority Data
Oct. 20, 2005 (JP) 2005-305476

(51) Int. Cl. D02J 1/22; B29D 22/00; D01D 7/00; D02G 1/00; D02G 3/02; D01F 8/14; D02G 3/24

(52) U.S. Cl. 428/34.8; 264/171.26

(57) ABSTRACT

A highly crimped conjugate fiber cheese package which is obtained by layering on a paper bobbin a conjugate fiber consisting of a plurality of single filament composed of polytrimethylene terephthalate components having different intrinsic viscosities and consisting of at least 90 mol % of a trimethylene terephthalate unit and no more than 10 mol % of another ester repeating unit and laminated to each other in a side-by-side type, the cheese package being characterized by satisfying the following conditions (1)-(4).

(1) The single filament composing the conjugate fiber has cross-sectional shape which is flat cross-section with a flatness of 1.1-3 as the ratio between the long axis and short axis.

(2) The developed crimp elongation of the conjugate fiber is 30-200%.

(3) The relationship between the contact area (compressed net area) S (cm²) between the paper bobbin and conjugate fiber and the wound weight W (kg) satisfies the following formula (1):

2≦W≦0.02S (Formula 1)
where 240≦S≦1000

(4) The package density of the conjugate fiber cheese package is 0.92-1.05 g/cm³.

### TECHNICAL FIELD

The present invention relates to a polytrimethylene terephthalate-based highly crimped conjugate fiber cheese package obtained by a direct spin-drawing/heat treatment process, and to a process for its production.

### BACKGROUND ART

Polytrimethylene terephthalate (hereinafter abbreviated as PTT) fiber has a low modulus and excellent elongation recovery, and has become widely used in the industry in recent years for their softness and stretch properties.

In order to more effectively bring out the stretch properties of PTT fiber, it has been proposed to use PTT for at least one of the components of single filament or to use two-component side-by-side type conjugate fiber comprising PTT with different intrinsic viscosities for both components (hereinafter referred to as PTT conjugate fiber).

PTT conjugate fiber employing PTT with different intrinsic viscosities for both components is able to exhibit the softness and elongation recovery of PTT and are therefore superior in terms of exhibiting the features of PTT compared to conjugate fiber employing PTT for only one of the components.

Production processes for PTT conjugate fiber include processes in which a spinning step and drawing step are carried out in two stages (hereinafter referred to as “two-stage processes”) and one-stage processes in which they are carried out continuously, also known as direct spin-drawing/heat treatment processes.

Take-up in the known two-stage processes involves winding up onto a bobbin comprising a thin plastic cylinder covering a metal bobbin with high compressive strength, such as aluminum.

Since a metal bobbin is usually used in a two-stage process, the bobbin does not undergo compressive deformation even with high winding tension or a high boiling water shrinkage ratio of the drawn yarn. A high boiling water shrinkage ratio is particularly advantageous for increasing the crimp performance of conjugate fiber that utilizes the post-heat treatment differential shrinkage of two components to exhibit crimp performance.

However, two-stage processes have at least two disadvantages compared to single-stage processes.

One disadvantage is that the wound form is tapered, making it impossible to obtain a high wound weight. The maximum wound weight of PTT conjugate fiber achievable with a two-stage process is 2-3 kg. As textile machines have become faster and more energy-efficient in recent years, the two-stage processes are less able to produce increased wound weights.

The other disadvantage is difficulty in achieving labor savings in the filament production step. Because a two-stage process accomplishes spinning and drawing in different stages, it requires more labor than a single-stage process and as a result the filament production cost is increased. For this reason, single-stage processes have come to be considered in recent years for direct spin-drawing/heat treatment processes.

Patent document 1 proposes PTT conjugate fiber with high shrinkage stress, using PTT with different intrinsic viscosities for the single filament components.

Patent document 2 describes PTT conjugate fiber suitable for false twisting. This PTT conjugate fiber exhibits a soft hand quality and a satisfactory stretchback property with false twisting, and it is disclosed that these properties are of a suitable level for various types of stretch fabrics or bulky fabrics.

Patent document 3 discloses a PTT conjugate fiber-layered package that has reduced tension variation during reeling of the conjugate fiber from the package.

While direct spin-drawing/heat treatment processes provide the advantage of lower production cost compared to two-stage processes as mentioned above, some problems remain to be solved in terms of crimp performance of the PTT conjugate fiber, package winding and prolonged high-temperature storage.

One of the problems of direct spin-drawing/heat treatment processes is a package tightening during winding.

Winding in a direct spin-drawing/heat treatment process is accomplished by layering the conjugate fiber on a cylindrical bobbin usually made of a paper material (hereinafter referred to as “paper bobbin”) into a package with a wound weight of 2 kg to a few dozen kilograms.

The PTT conjugate fiber that has been produced by the direct spin-drawing/heat treatment process and wound on the paper bobbin experiences elongation stress during the drawing, which remains as shrinkage stress after layering into the package and causes shrinkage of the PTT conjugate fiber. The shrinkage compresses the paper bobbin and results in package tightening. If the package tightening is severe, it can sometimes be impossible to remove the package from the bobbin shaft of the winder. Such package tightening can hamper industrial production.

If the only concern is removal of the package from the bobbin shaft of the winder, then it is sufficient to reinforce the paper bobbin to increase the compressive strength, regardless of economical considerations. However, packages wound by such processes have poor wound forms.

Examples of poor wound forms include bulging of the package center section in the direction of the paper bobbin length, and “saddling” where the edges of the package extend outward in the diameter direction of the paper bobbin. When such problematic forms are notable, it becomes difficult to pack the package and quality is reduced, which may result in poor reeling of the filament from the package.

A second problem with direct spin-drawing/heat treatment processes is that prolonged storage of the packages at high temperature leads to reduction in quality and reeling performance of the innermost wound PTT conjugate fiber.

When a PTT conjugate fiber with high crimp performance is exposed to a high temperature of 45° C. or above for prolonged periods during transport or storage, a package tightening due to shrinkage of the PTT conjugate fiber wound in the package produces a poor package form as mentioned above, or the portions of the filament at the inner core (meaning the section up to a wound thickness of about 1 mm from the paper bobbin) become essentially “fused”.

When a PTT conjugate fiber is reeled at a high speed of 400-1000 m/min from a package in which such package tightening has occurred, the variation in reeling tension of the PTT conjugate fiber at the inner core of the package increases significantly, resulting in frequent yarn breakage during reeling of sections knotted with the surface yarn of another package, i.e. during “tail transfer”. Moreover, it has been demonstrated that packages that have undergone package tightening also contain dyeing quality defects in the PTT conjugate fiber at the inner core.

Due to such problems with wound packages, therefore, it has been extremely difficult to increase the crimp performance of PTT conjugate fiber obtained by direct spin-drawing/heat treatment processes, compared to PTT conjugate fiber obtained by two-stage processes.

On the other hand, when a PTT conjugate fiber obtained by a direct spin-drawing/heat treatment process is provided for a high density fabric directly without false twisting, it has been necessary to increase the crimp performance of the PTT conjugate fiber to a degree suitable for false twisted yarn.

Specifically, when a PTT conjugate fiber obtained by a direct spin-drawing/heat treatment process is used without false twisting in a fabric with a large fiber restraint force such as one having a cover factor of about 2000-4000 as represented by the formula shown below (a high-density fabric), it is not possible to achieve sufficient stretch performance even when the fabric is heat treated to take advantage of the differential shrinkage of the conjugate fiber for crimping. In other words, it is very difficult to obtain a stretch ratio of 10% or greater for a high-density fabric composed of PTT conjugate fiber.

Cover factor=(warp yarn count×(warp yarn decitex×0.9)^{1/2}+weft yarn count×(weft yarn decitex×0.9)^{1/2})

The warp yarn and weft yarn counts are per inch (2.54 cm).

In order to enhance the stretch performance of a high-density fabric it is necessary to increase the crimp performance of the conjugate fiber. However, increasing the crimp performance of the conjugate fiber in the prior art has required a higher winding tension or boiling water shrinkage ratio of the conjugate fiber, while increasing the crimp performance also has produced package tightening.

On a laboratory scale, for example, winding of a package to a small wound weight of about 100 g still allows a highly crimped PTT conjugate fiber to be obtained. But when it is attempted to obtain a package with an industrially practical wound weight, some of the resulting problems include increased bulging which makes it impossible to accomplish packaging, tightening of the package making it difficult to remove the package from the winder, and a poor reeling property during reeling of the PTT conjugate fiber from the package when it is exposed to high temperature for prolonged periods.

In other words, a PTT conjugate fiber produced by direct spin-drawing/heat treatment processes in the prior art has been associated with the problem that involves trade-off between obtaining a package with a satisfactory wound form and achieving a high crimp property. It has therefore been a much desired goal in the industry to obtain a PTT conjugate fiber by direct spin-drawing/heat treatment processes that exhibit high crimping comparable to that of a PTT conjugate fiber produced by two-stage processes.

These problems associated with PTT conjugate fiber package winding and the problems of reeling and dyeing quality of filaments at the inner core are nowhere mentioned in the aforementioned Patent documents 1, 2 and 3.

Patent document 4 proposes a production process for polyester partially oriented yarn wherein the take-up speed is gradually increased to 0.1-2.0% with respect to the initial take-up speed to the maximum take-up speed, until reaching 10-40 wt % of the total wound weight.

However, while this process proposed in Patent document 4 exhibits a certain effect of improving the dyeing quality of polyethylene terephthalate partially oriented yarn having a breaking elongation of about 100-150%, it has been difficult to solve the problems related to maintaining package form at high temperature and the reeling property of the PTT conjugate fiber at the inner core, for PTT conjugate fiber with different molecular structures and for highly crimped drawn yarn.

It has therefore been strongly desirable to develop a PTT conjugate fiber cheese package wherein the PTT conjugate fiber is taken up into a cheese package with a wound weight of 2 kg or greater by a direct spin-drawing/heat treatment process, such that the package exhibits a satisfactory wound form and a high crimp property, excellent maintenance of the package form during prolonged periods of high temperature, and no problems such as reduced reelability, dyeing spots and color differences in the inner core, as well as a process for its production.

[Patent document 1] Japanese Unexamined Patent Publication No. 2001-55634
[Patent document 2] WO2003/100145
[Patent document 3] WO2003/040011
[Patent document 4] Japanese Patent Publication No. 2854245

### DISCLOSURE OF THE INVENTION

### Problems to be Solved by the Invention

In a PTT conjugate fiber produced by direct spin-drawing/heat treatment processes in the prior art, there were problems between obtaining a package with a satisfactory wound form and achieving a high crimp property which can hardly be satisfied at the same time. It has therefore been a much desired goal in the industry to obtain a PTT conjugate fiber by a direct spin-drawing/heat treatment process that exhibits high crimping comparable to a fiber obtained by a two-stage process.

The first aspect of the invention provides a PTT conjugate fiber cheese package obtained by a direct spin-drawing/heat treatment process, obtained by winding a cheese package to a wound weight of 2 kg or greater from a PTT conjugate fiber while exhibiting a satisfactory wound form and high crimp performance even when used in high-density fabrics, as well as a process for its production.

The second aspect of the invention provides a highly crimped conjugate fiber cheese package that maintains an excellent package form even when the PTT conjugate fiber cheese package is exposed to high temperature for prolonged periods, and which exhibits satisfactory reelability of the inner core when the conjugate fiber is reeled from the package and is free of problems such as color differences and dyeing spots, as well as a process for its production.

### Means for Solving the Problems

As a result of much diligent research aimed at solving the aforementioned problems, the present inventors have discovered that when a PTT conjugate fiber is produced by a direct spin-drawing/heat treatment process, if the PTT conjugate fiber cheese package used has specified ranges for the cross-sectional shape of the PTT conjugate fiber and the paper bobbin used for take-up and the take-up conditions, and especially the shrinkage factor, it is possible to achieve satisfactory high crimp performance of the conjugate fiber while retaining the cheese package form, thereby overcoming the problems faced in the prior art, and the invention has been completed upon this discovery.

Specifically, the present invention provides the following.

1. A highly crimped conjugate fiber cheese package which is obtained by layering on a paper bobbin a conjugate fiber consisting of a plurality of single filament composed of polytrimethylene terephthalate components having different intrinsic viscosities and consisting of at least 90 mol % of a trimethylene terephthalate unit and no more than 10 mol % of another ester repeating unit and laminated to each other in a side-by-side type, the cheese package being characterized by satisfying the following conditions (1)-(4).

(1) The single filament composing the conjugate fiber has cross-sectional shape which is flat cross-section with a flatness of 1.1-3 as the ratio between the long axis and short axis.
(2) The developed crimp elongation of the conjugate fiber is 30-200%.
(3) The relationship between the contact area (compressed net area) S (cm²) between the paper bobbin and conjugate fiber and the wound weight W (kg) satisfies the following formula (1):

2≦W≦0.02S (Formula 1)

where 240≦S≦1000

(4) The package density of the conjugate fiber cheese package is 0.92-1.05 g/cm³.

2. A highly crimped conjugate fiber cheese package according to 1. above, characterized in that the crimp elongation of the conjugate fiber is 4-30% after dry heat treatment for 30 minutes at 90° C. under a load of 0.9×10⁻² cN/dtex.

3. A highly crimped conjugate fiber cheese package according to 1. above, characterized in that the crimp elongation of the conjugate fiber is 8-30% after dry heat treatment for 30 minutes at 90° C. under a load of 0.9×10⁻² cN/dtex.

4. A highly crimped conjugate fiber cheese package according to any one of 1., 2. or 3. above, characterized in that the value for the reeling tension value (package performance factor, PPF) of the conjugate fiber layered to a thickness of about 1 mm in the most inner core is 0-100, as measured after heat treatment of the cheese package at 45° C. for 24 hours.

5. A highly crimped conjugate fiber cheese package according to any one of 1. to 4. above, characterized in that the percentage reduction d(%) is 0-30%, as measured after heat treatment of the cheese package at 45° C. for 24 hours and calculated by the following formula (2) from the finishing agent deposit efficiency (a) on 1 g of the most inner core fiber and the finishing agent deposit efficiency (b) on the conjugate fiber layered on the surface section.

d=(b−a)/b×100 (Formula 2)

6. A highly crimped conjugate fiber cheese package according to any one of 1. to 5. above, characterized in that the paper bobbin used is a waterproofed-oilproofed paper bobbin with a water absorption of no greater than 40 g/m²·15 min as measured on the take-up paper bobbin surface according to JIS-P-8140:1988.

7. A highly crimped conjugate fiber cheese package according to any one of 1. to 6. above, characterized in that the contact area (compressed net area) S between the paper bobbin and conjugate fiber is 300-800 (cm²), and the wound weight W is 3-20 (kg).

8. A highly crimped conjugate fiber cheese package according to any one of 1. to 7. above, characterized in that the package density of the conjugate fiber cheese package is 0.93-1.03 g/cm³.

9. A process for production of a highly crimped conjugate fiber cheese package wherein after melt spinning of a conjugate fiber consisting of a plurality of single filament composed of polytrimethylene is terephthalate components having different intrinsic viscosities and consisting of at least 90 mol % of a trimethylene terephthalate unit and no more than 10 mol % of another ester repeating unit and laminated to each other in a side-by-side type, and cooling solidification with cooling air to form single filament having flat cross-section with a flatness of 1.1-3, at least three heating rolls are used for direct spin-drawing/heat treatment and the conjugate fiber is taken up onto a paper bobbin at a take-up speed of 2000-5000 m/min to form a cheese package with a wound weight of 2 kg or greater, characterized in that the following conditions (A)-(D) are satisfied.

(A) Drawing is to a breaking elongation of 25-40%.
(B) The conjugate fiber is heat treated with a suitable combination of temperature and tension ratio at the final heating roll until the shrinkage factor of the conjugate fiber measured immediately after take-up is 0.3-1.0%.
(C) The flat compressive strength of the paper bobbin is 1000-7000 N.
(D) Take-up is with a contact area (compressed net area) S (cm²) of 240-1200 cm² between the paper bobbin and conjugate fiber.

10. A process for production of a highly crimped conjugate fiber cheese package according to 9 above, characterized in that the tension To at the final heating roll exit point and the tension Ti at the traverse guide entrance point (winding tension) during take-up of the cheese package are controlled to within the ranges specified by the following formulas (3) and (4).

0≦Ti−To≦0.05 (cN/dtex) (Formula 3)

0.05<Ti≦0.20 (cN/dtex) (Formula 4)

11. A process for production of a highly crimped conjugate fiber cheese package according to 9. or 10. above, characterized in that during take-up of the conjugate fiber, the traverse angle at a take-up thickness of 1 mm is no greater than half the maximum traverse angle during take-up of the package.

12. A highly crimped conjugate fiber cheese package according to any one of 1. to 8. above, wherein the package is obtained by layering on a paper bobbin a highly crimped conjugate fiber, the conjugate fiber satisfying the following conditions (1), (2), (5) and (6).

(1) The single filament cross-sectional shape in the conjugate fiber is flat cross-section with a flatness of 1.1-3 as the ratio between the long axis and short axis.
(2) The developed crimp elongation of the conjugate fiber is 30-200%.
(5) The crimp elongation of the conjugate fiber is 4-30% after dry heat treatment for 30 minutes at 90° C. under tension of 0.9×10⁻² cN/dtex.
(6) The extreme temperature for dry heat shrinkage stress of the conjugate fiber is 195-225° C., and the extreme stress is 0.05-0.20 cN/dtex.

The present invention will now be explained in greater detail.

According to the invention, the PTT composing the conjugate fiber comprises at least 90 mol % of a trimethylene terephthalate repeating unit and no greater than 10 mol % of another ester repeating unit. Specifically, the PTT of the conjugate fiber may be a PTT homopolymer, or it may be a PTT copolymer containing no more than 10 mol % of another ester repeating unit.

The following may be mentioned as examples of copolymerizing components for PTT copolymers.

As acidic components there may be mentioned aromatic dicarboxylic acids such as isophthalic acid and 5-sodiumsulfoisophthalic acid, and aliphatic dicarboxylic acids such as adipic acid and itaconic acid. As glycol components there may be mentioned ethylene glycol, butylene glycol, polyethylene glycol and the like. Hydroxycarboxylic acids such as hydroxybenzoic acid are also typical examples. A plurality of the above may also be copolymerized.

Copolymerization of trifunctional crosslinking components such as trimellitic acid, pentaerythritol and pyromellitic acid is preferably avoided because they impair the spinning stability.

The process employed for polymerization of the PTT used for the invention may be any known process. For example, it may be a single-stage process by melt polymerization alone to a polymerization degree corresponding to the prescribed intrinsic viscosity, or a two-stage process wherein the polymerization degree is increased to the prescribed intrinsic viscosity by melt polymerization, and then to a polymerization degree corresponding to the prescribed intrinsic viscosity by solid-phase polymerization.

For a high intrinsic viscosity component, it is preferred to use a two-stage process including solid-phase polymerization in order to reduce the cyclic dimer content.

When the polymerization degree is increased to the prescribed intrinsic viscosity by a single-stage process, it is preferred to first reduce the cyclic dimers by extraction or the like before supply to the spinning step.

The PTT used for the invention preferably has a trimethylene terephthalate cyclic dimer content of no greater than 2.5 wt %. The trimethylene terephthalate cyclic dimer content of the high intrinsic viscosity component is more preferably less than 1.2 wt % and most preferably no greater than 1.0 wt %.

According to the invention, the PTT may contain another polyester such as polyethylene terephthalate or polybutylene terephthalate, or a polymer other than a polyester at no greater than 10 mol % so long as the spinning property is not impaired. Additives including delustering agents such as titanium oxide, heat stabilizers, antioxidants, antistatic agents, ultraviolet absorbers, antimicrobial agents and pigments may also be included, or copolymerized therewith, so long as they do not interfere with the effect of the invention.

The cheese package of the invention is obtained by layering a highly crimped conjugate fiber consisting of a plurality of single filament with different intrinsic viscosities, composed of PTT components consisting of at least 90 mol % of a trimethylene terephthalate unit and no more than 10 mol % of another ester repeating unit and laminated to each other in a side-by-side type, onto a package in a cheese shape.

The high intrinsic viscosity component generally has high alignment and a high shrinkage property, while the low intrinsic viscosity component generally has low alignment and a low shrinkage property.

It is preferred to select PTT with an intrinsic viscosity of 0.7-1.5 dl/g for the high intrinsic viscosity component and PTT with an intrinsic viscosity of 0.5-1.2 dl/g as the low intrinsic viscosity component. The difference in intrinsic viscosities of the high intrinsic viscosity component and low intrinsic viscosity component is preferably 0.05-0.8 dl/g and more preferably 0.1-0.5 dl/g.

If the difference in intrinsic viscosities is within this range, the drawing and take-up conditions can be adjusted to obtain excellent crimp performance, while yarn bending and yarn breakage directly under the spinneret will be minimal and the high intrinsic viscosity component will be satisfactorily aligned, so that the conjugate fiber will have strength of 1 cN/dtex or greater and a fabric with sufficient strength can be obtained.

The mean intrinsic viscosity is preferably 0.6-1.2 dl/g and even more preferably 0.8-1.1 dl/g in order to ensure strength of the obtained conjugate fiber.

If the mean intrinsic viscosity is within this range, the conjugate fiber strength will be greater than about 1 cN/dtex and the filament will be suitable for sports applications that require high strength. If the intrinsic viscosity is too high, however, the conjugate fiber strength will tend to be less than about 1 cN/dtex.

According to the invention, the blending ratio of the two PTT components with different intrinsic viscosities in the conjugate fiber, in the single filament cross-section, is preferably 35/65-65/35, even more preferably 40/60-60/40 and most preferably 40/60-50/50, as the ratio of the high intrinsic viscosity component and low intrinsic viscosity component. If the ratio of the high intrinsic viscosity component and low intrinsic viscosity component is within this range it will be possible to obtain excellent crimp performance, a yarn strength of about 1 cN/dtex or greater, and suitability for sports applications.

The cheese package of the invention is a cheese package obtained by taking up a conjugate fiber produced by direct spin-drawing/heat treatment involving continuous melt spinning-drawing.

The cheese package of the invention has a wound weight of at least 2 kg. If the wound weight is less than 2 kg, it will be necessary to replace the package more frequently during weaving or knitting, thus presenting an economical disadvantage in terms of labor and operating cost. A preferred wound weight is about 3 kg or greater, with 4 kg or greater being more preferred. Although there is no upper limit for the wound weight, about 20 kg is the maximum from the viewpoint of labor and handling.

The conjugate fiber wound into the cheese package of the invention must have a single filament cross-section that is flat with a flatness of 1.1-3 as the ratio of the long axis and short axis. The flatness is represented as the ratio of the long axis (w in FIGS. 1a and b) and the short axis (h in FIGS. 1a and b) of a circumscribed rectangle around the cross-sectional shape.

A flat cross-sectional shape will allow increased crimp performance even with a small difference in intrinsic viscosities between the high intrinsic viscosity component and low intrinsic viscosity component. With a flatness of less than 1.1, it will be difficult to increase the latent crimping performance of the conjugate fiber by a direct spin-drawing/heat treatment process. If the flatness exceeds 3, shininess may be exhibited due to glossy spots in the obtained fabric, thus lowering the quality of the product. The preferred flatness range is 1.5-2.5.

The specific flat shape, illustrated in FIGS. 1a and 1b, is preferably a “peanut” shape (shown in FIG. 1a) or “snowman” shape (shown in FIG. 1b).

The conjugate fiber wound on the cheese package of the invention must also have a developed crimp elongation of 30-200%. If the developed crimp elongation of the conjugate fiber is less than 30%, the stretch property may be insufficient when it is used in a high-density fabric or the like. Although a higher developed crimp elongation is preferred, a developed crimp elongation exceeding 200% may result in fluff or yarn breakage during spinning and drawing, thus hampering industrial production. The preferred developed crimp elongation range is 40-150% and more preferably 50-150%.

A high developed crimp elongation is an essential condition for expressing excellent crimp when the conjugate fiber is used in a high density fabric without false twisting, but in the past it has been very difficult to exhibit high developed crimp elongation with PTT conjugate fiber in direct spin-drawing/heat treatment processes, as compared to a conjugate fiber comprising only PTT or a conjugate fiber including components other than PTT.

For the cheese package of the invention, it is essential for the relationship between the contact area (compressed net area) S (cm²) between the paper bobbin and conjugate fiber and the wound weight W (kg) to satisfy the following formula (1).

2≦W≦0.02S (Formula 1)

where 240≦S≦1000

This relationship represented by Formula 1 is illustrated in FIG. 2 with the contact area (compressed net area) S (cm²) between the paper bobbin and conjugate fiber on the horizontal axis and the wound weight W (kg) of the PTT conjugate fiber on the vertical axis.

In formula (1), a wound weight W (kg) exceeding 0.02S results in tightening of the PTT conjugate fiber cheese package or poor reelability at the inner core upon prolonged exposure to high temperature, even when the strength of the paper bobbin is increased. With a wound weight of less than 2 kg, the conjugate fiber can be taken up but the filament cost is increased, thus posing a disadvantage for industrial implementation.

The contact area (compressed net area) S (cm²) between the paper bobbin and conjugate fiber is the value calculated from the outer diameter of the paper bobbin on which the conjugate fiber is wound, and the wound width. More specifically, it is calculated by S=π×D×L (cm²), with the paper bobbin outer diameter as D (cm) and the mechanical traverse width of the winder as L (cm).

The reason for limiting the contact area (compressed net area) S (cm²) to 240-1000 (cm²) according to the invention is in order to obtain a practical flat compressive strength with a given outer diameter of the paper bobbin and wound width. The preferred range for the contact area S is 300-800 (cm²), with 550-800 cm² being the most preferred range. In practical terms, the outer diameter of the paper bobbin is preferably 7-15 cm and most preferably 10-13 cm.

The cheese package of the invention preferably has a wound width of 7-30 cm. A larger wound width will permit an increased wound weight of the package, which is industrially advantageous as it increases the efficiency of package replacement in later steps. Moreover, a larger wound width improves the form retention of the cheese package even when the conjugate fiber has high crimp performance.

A wound width exceeding 30 cm, however, may result in a reeling tension (PPF) of greater than 100 in the section up to a 1 mm thickness from the inner core, when the conjugate fiber is subsequently reeled from the package.

For equipment that simultaneously accomplishes take-up of multiple ends with a single winder, the shaft length T that anchors and rotates the package is determined by the product of the paper bobbin length (generally about 1-5 cm longer than the wound width) and the number of ends, and since this length T is longer in proportion to the wound width, an excessively large wound width is economically disadvantageous since the winder will be excessively increased in size. The wound width is preferably 15-25 cm and most preferably 17-22 cm.

The cheese package of the invention must also have a package density of 0.92-1.05 g/cm³ for the conjugate fiber wound on the cheese package.

A package density of less than 0.92 g/cm³ will result in a developed crimp elongation of less than 30%, making it impossible to achieve the object of the invention. If the package density exceeds 1.05 g/cm³, it will be difficult to dispense the package from the winder due to package tightening during take-up. The preferred range for the package density is 0.93-1.03 g/cm³, with 0.93-1.00 g/cm³ being more preferred. The package density is the value obtained by dividing the wound weight described hereunder by the volume of the package.

According to the invention, the breaking elongation of the conjugate fiber is preferably 25-40% and more preferably 25-35%. A breaking elongation within this range will ensure that the internal stress of the package does not increase excessively, so that the package reelability will be satisfactory and stable filament production will be possible without fluff or yarn breakage, with a high developed crimp elongation as well.

The conjugate fiber wound on the cheese package of the invention preferably has a crimp elongation of 4-30%, more preferably 8-30% and even more preferably 10-25% after dry heat treatment under tension of 0.9×10⁻² cN/dtex. The crimp elongation is calculated as follows, after dry heat treatment at a treatment temperature of 90° C. under tension of 0.9×10⁻² cN/dtex, according to the dry heat shrinkage factor measurement method of JIS-L1013.

Crimp elongation %=(L4−L3)/L3×100

L3=Hank length with a tension of 0.9×10⁻² CN/dtex
L4=Hank length with a tension of 0.18 cN/dtex

If the crimp elongation of the conjugate fiber is within the aforementioned range, the stretch property will be sufficient for woven and knitted fabrics and a satisfactory package form will be obtained without package tightening during take-up, thus facilitating industrial production.

The reason for a tension of 0.9×10⁻² cN/dtex during dry heat treatment according to the invention is based on knowledge of the present inventors that the crimp elongation measured under the tension corresponds well to the stretch ratio of high-density fabric products.

The cheese package of the invention preferably has a reeling tension value (PPF) of 0-100 and more preferably 0-50 for the inner core as measured after heat treatment of the package by dry heat at 45° C. for 24 hours.

This reeling tension value (PPF=Package Performance Factor) is measured by the method described below, and indicates the reelability when the conjugate fiber is reeled from the package. Measurement and statistical processing of the reeling tension allows quantitative evaluation of reelability.

A smaller reeling tension value (PPF) means more satisfactory reelability. If the reeling tension value (PPF) is 0-100, the reelability will be satisfactory without yarn breakage or similar problems even with high-speed reeling of 400-1000 m/min. Yarn breakage will tend to occur during reeling if the reeling tension value (PPF) is greater than 100 and less than 500, while a reeling tension value (PPF) of greater than 500 will hamper high-speed reeling of 400-1000 m/min and tend to cause more yarn breakage.

PTT conjugate fiber with high latent crimping has conventionally had poor reelability from cheese packages compared to PTT fiber without crimping or PTT conjugate fiber with low latent crimping, but the invention solves this problem for the first time.

FIG. 3 shows an example with a low reeling tension value (PPF) and satisfactory reelability.

FIG. 4 shows an example with a high reeling tension value (PPF) and poor reelability.

The reason for which the properties are evaluated after heat treatment of the cheese package by dry heat at 45° C. for 24 hours according to the invention is that the properties that have been altered when the package is exposed to high temperature for prolonged periods during transport or storage are important as properties of the cheese package. The reason for a time of 24 hours is that the properties deteriorate with time within 24 hours but become essentially stabilized after 24 hours to constant values.

According to the invention, the conjugate fiber has an extreme temperature of 190-225° C. and extreme stress of 0.05-0.20 cN/dtex for the dry heat shrinkage stress. If the extreme temperature and extreme stress for the dry heat shrinkage stress are within these ranges, the filament shrinkage will be minimal and the reelability satisfactory even when the package is exposed to high temperature for prolonged periods, while yarn breakage during drawing will be low allowing stable production, and an excellent developed crimp elongation will be obtained.

The preferred extreme temperature is 190-220° C. and the preferred extreme stress is 0.07-0.17 cN/dtex, for the dry heat shrinkage stress.

For the cheese package of the invention, the percentage reduction d is 0-30%, calculated from the finishing agent deposit efficiency (a) for 1 part by weight of inner core fiber and the finishing agent deposit efficiency (b) on the conjugate fiber layered on the surface section, measured after dry heat treatment of the cheese package at 45° C. for 24 hours. The percentage reduction (d) is calculated by the following formula.

Percentage reduction d=(b−a)/b×100(%)

where (b) is the finishing agent deposit efficiency on the surface fiber,

and (a) is the finishing agent deposit efficiency for 1 part by weight of fiber at the inner core.

A percentage reduction of greater than 30% will tend to cause impairment of woven fabric quality with running variations of the conjugate fiber in an AJL (air jet loom), or impairment of knitted fabric quality with changes in friction between the conjugate fiber and the knitting needle. A smaller percentage reduction is preferred, and the effect on quality will be minimal if it is below 10%.

A process for production of a cheese package of the invention will now be explained.

For production of a cheese package of the invention there is employed a composite spinning apparatus having a two-stage extruder, as described below. At least three heating rolls are used for production of a cheese package according to the invention, for the reason described below.

FIG. 5 shows a schematic view of an example of a composite spinning apparatus used for the production process of the invention.

In the process illustrated in FIG. 5, it is preferred to supply PTT with a high intrinsic viscosity at one end A and PTT with a low intrinsic viscosity at the other end B, for discharge. It is preferred to select PTT with an intrinsic viscosity of 0.7-1.5 dl/g for the high intrinsic viscosity component and PTT with an intrinsic viscosity of 0.5-1.2 dl/g as the low intrinsic viscosity component. The difference in intrinsic viscosities of the high intrinsic viscosity component and low intrinsic viscosity component is preferably 0.05-0.8 dl/g and more preferably 0.1-0.5 dl/g.

If the difference in intrinsic viscosities is within this range, the drawing and take-up conditions can be adjusted to obtain excellent crimp performance, while yarn bending and yarn breakage directly under the spinneret will be minimal and the high intrinsic viscosity component will be satisfactorily aligned, so that the conjugate fiber will have strength of 1 cN/dtex or greater and a fabric with sufficient strength can be obtained.

The spinneret used for the production process of the invention is preferably a type such that the high intrinsic viscosity component and low intrinsic viscosity component discharge holes merge between the discharge surface and immediately after discharge. The advantage of using this type of spinneret is that it allows stable spinning without yarn bending immediately under the nozzle even with a large difference of 0.1-0.5 dl/g in the intrinsic viscosities.

The shape of the discharge hole may be the same or different at the high intrinsic viscosity and low intrinsic viscosity ends. More preferably, both have the same circular or oval shape.

When using a spinneret with two adjacent oval shapes, the single filament cross-sectional shape of the obtained conjugate fiber will be a “peanut” shape. By using such a spinneret with different blending ratios of the discharged high intrinsic viscosity component and low intrinsic viscosity component, it is possible to produce a “snowman” shape for the single filament cross-sectional shape of the obtained conjugate fiber.

The flatness of the single filament cross-sectional shape may be adjusted by specifying primarily the shape of the discharge hole but also the distance between the two oval holes.

The production process of the invention will now be explained with reference to the apparatus shown in FIG. 5.

First, PTT with high intrinsic viscosity is dried with a drier 1 to a moisture content of no greater than 20 ppm and supplied to an extruder 2 set to a polymer temperature of 240-280° C. for melting. PTT with low intrinsic viscosity is also dried with the drier 3 to a moisture content of no greater than 20 ppm and supplied to an extruder 4 set to a polymer temperature of 240-280° C. for melting.

Each molten PTT is conveyed through a bend 5 or 6 to a spin head 7 set to 250-280° C., and is separately weighed with a gear pump. Next, the two components are merged at a spinneret 9 with multiple holes that is mounted in a spin pack 8 and after being laminated to each other in a side-by-side type, are extruded into the spinning chamber as a multifilament.

After passing through a non-blast zone 11 with a length of 3-20 cm, the conjugate fiber 10 extruded into the spinning chamber is cooled to room temperature with a cooling air 12 for solidification and a finishing agent is applied with a finishing agent application nozzle 13, after which an interlacing nozzle 18 is used for interlacing. Next, before being taken up, the filament passes through a first heating roll 14 rotating at a prescribed speed, and subsequently through a second heating roll 15 and then a third heating roll 16, and finally to a winder for take-up of the conjugate fiber package 17 with the prescribed fineness.

The temperature of the extruder and spin head are selected from the ranges specified above as appropriate for the intrinsic viscosity and shape of the PTT polymer.

As mentioned above, at least three heating rolls are used according to the invention. The final heating roll used for the invention is the last heating roll in the process, and when three heating rolls are used it is the third heating roll.

After spinning and before the cooled and solidified PTT conjugate fiber 10 contacts the first heating roll 14, the filament is coated with a finishing agent using a finishing agent applicator 13 for more satisfactory reelability of the package. The finishing agent coated onto the conjugate fiber may be an aqueous emulsion type.

The concentration of the aqueous emulsion in the finishing agent is 10 wt % or greater and preferably 15-30 wt %. The type of finishing agent is preferably one either containing 10-80 wt % of a fatty acid ester and/or mineral oil, or containing 50-98 wt % of a polyether with a molecular weight of 1000-20,000, and it is preferably applied at 0.3-1.5 wt % with respect to the fiber.

The conjugate fiber may, if necessary, be interlaced with an interlacing apparatus 18 between the finishing agent applicator 13 and first heating roll 14, and/or between the first heating roll 14 and second heating roll 15, and/or between the second heating roll 15 and third heating roll 16 and/or between the third heating roll 16 and winder. The interlacing apparatus used may be a known interlacer, and for example, the fluid pressure may be adjusted to 0.01-0.6 MPa for interlacing at 2-50 interlaces/m.

In order to stabilize the conjugate fiber take-off speed, the first heating roll 14 has a mirror roll surface and the arithmetic mean roughness Ra of the surface is preferably no greater than 0.2 a and even more preferably no greater than 0.05 a. The first heating roll preferably has a shape where the diameter of the yarn exit port is gradually increased to 2-7% greater than the diameter of the yarn entrance port, and specifically, using a tapered roll that allows the circumferential speed to gradually increase by 2-7% is more preferred in order to maintain tension of the conjugate fiber on the first heating roll 14.

In order to reduce concentration of stress when the conjugate fiber is heat set on the rolls, the second heating roll 15 and third heating roll 16 preferably have textured surfaces and more preferably textured rolls are used wherein the arithmetic mean roughness Ra of the surfaces is 0.4 a or greater and even more preferably 0.6-1.6 a.

The cheese package of the invention is produced by a direct spin-drawing/heat treatment process comprising spinning and drawing followed by continuous take-up.

The temperature of the first heating roll 14 is preferably 50-90° C. and more preferably 55-70° C. A first heating roll temperature within this range will allow stable production without generation of fluff or yarn breakage during drawing.

The first heating roll 14 speed is preferably 1500-4000 m/min. If the first heating roll speed is within this range, the yarn tension will be suitable and swaying of the yarn will be reduced to almost completely eliminate yarn breakage, while pre-alignment of the unstretched yarn will also be avoided to allow a high draw ratio, thus yielding a conjugate fiber with a strength of about 1.5 cN/dtex or greater and permitting its use for a wide range of purposes.

The conjugate fiber is taken up with a winder through the first heating roll 14, second heating roll 15 and third heating roll 16.

In the production process of the invention, the circumferential speeds of the first heating roll 14 and second heating roll 15 may be different in order to accomplish drawing between the first heating roll and second heating roll and set the breaking elongation of the conjugate fiber to 25-40%. The draw ratio will differ depending on the intrinsic viscosity of the conjugate fiber and the speed of the first heating roll, etc., but it is preferably a factor of 1.1-3 and more preferably a factor of 1.1-2.5. If the draw ratio is within this range, the breaking elongation of the conjugate fiber will be between 25% and 40%, so that the object of the invention will be achieved while accomplishing stable production with virtually no yarn breakage during drawing.

Heat treatment must be carried out between the second heating roll 15 and third heating roll 16 in the production process of the invention. The temperature of the second heating roll 15 is preferably 80-160° C. and more preferably 100-150° C. If the temperature of the second heating roll is within this range, the extreme temperature for dry heat shrinkage stress of the conjugate fiber will be above 190° C. and the package will satisfactorily maintain its form at high temperature, while yarn breakage will also be avoided during drawing.

Tensile heat treatment must also be carried out between the second heating roll 15 and third heating roll 16 in the production process of the invention. A preferred tension ratio is 0.97-1.10, with 1.00-1.05 being more preferred. If the tension ratio is within this range, it will be possible to achieve a crimp elongation of 4-30% for the conjugate fiber after dry heat treatment for 30 minutes at 90° C. under tension of 0.9×10⁻² cN/dtex.

The tension ratio is defined by the following formula.

Tension ratio=(circumferential speed of third heating roll)/(circumferential speed of second heating roll)

The purpose of the tensile heat treatment between the second heating roll 15 and third heating roll 16 is to maximize the difference in shrinkage factor or the difference in internal strain between the two components forming the conjugate fiber.

Polymers generally produce internal strain due to the stress experienced during drawing. This internal strain tends to increase with a higher degree of orientation of the polymer molecular chains. Release of this internal strain causes shrinkage of the filament.

Since the internal strain on the high intrinsic viscosity component side is large in a single filament of a conjugate fiber, the high intrinsic viscosity component is located at the inside of a crimp. The crimp performance is greater with a larger difference in internal strain between the high intrinsic viscosity and low intrinsic viscosity sides. Release of the internal strain during take-up of the conjugate fiber results in development of the crimp, producing latent crimping.

In order to maximize the difference in internal strain between the high intrinsic viscosity component and low intrinsic viscosity component sides, it is necessary to carry out tensile heat treatment with a suitable tension ratio. If the tension ratio is too small, the internal strain on the high intrinsic viscosity component side will be alleviated during heat treatment, thus reducing the difference in internal strain between the high intrinsic viscosity component and low intrinsic viscosity component and lowering the crimp performance. If the tension ratio is too large, on the other hand, the internal strain of the low intrinsic viscosity component will increase beyond the increase in internal strain of the high intrinsic viscosity component, thus lowering the difference in internal strain and, likewise, lowering the crimp performance.

According to the invention, therefore, the conjugate fiber must be subjected to stretching heat treatment following drawing, and must therefore be produced by a direct spin-drawing/heat treatment process employing at least three heating rolls.

In the production process of the invention, the shrinkage factor of the conjugate fiber must be set to 0.3-1.0%. A shrinkage factor of 0.3-1.0% will allow a conjugate fiber with high crimp performance to be taken up in a cheese package with a satisfactory wound form to wound weights of 2 kg and greater. This has been discovered for the first time by the present inventors.

The method of measuring the shrinkage factor will now be explained.

If the shrinkage factor is greater than 1%, a package tightening will tend to occur causing deformation of the package bulge and hampering stable take-up, even if the contact area of the paper bobbin and conjugate fiber and the flat compressive strength of the paper bobbin are increased. If the shrinkage factor is less than 0.3%, the developed crimp elongation of the PTT conjugate fiber will be lower than 30% and the object of the invention will not be achievable. A preferred shrinkage factor range is 0.4-0.8%.

The temperature and relaxation ratio during heat treatment with the third heating roll 16 may be adjusted to an appropriate combination to ensure that the shrinkage factor is within the aforementioned range. For example, in order to obtain a shrinkage factor of less than 1.0%, the third heating roll temperature may be set to 50° C. or higher and the relaxation ratio to 1% or greater, and to obtain a shrinkage factor of greater than 0.3%, the third heating roll temperature may be set to no higher than 150° C. and the relaxation ratio to no greater than 5%.

The temperature of the third heating roll 16 is preferably 50-150° C. and more preferably 70-130° C.

Relaxation to a relaxation ratio of 1-5% is preferably carried out between the third heating roll 16 and the winder. The relaxation ratio is calculated by the following formula.

Relaxation ratio=[(third heating roll speed/take-up speed)−1]×100(%)

The flat compressive strength of the paper bobbin used in the production process of the invention is 1000-7000 (N), preferably 2000-7000 N and even more preferably 4000-6000 (N). If the flat compressive strength of the paper bobbin is less than 1000 N, a package tightening will tend to occur when a conjugate fiber with a developed crimp elongation of 30% or greater is layered to a wound weight of 2 kg or greater. If the flat compressive strength of the paper bobbin exceeds 7000 N, it will be necessary to reduce the paper bobbin diameter to less than 7 cm or to increase the thickness of the paper bobbin to above 1.5 cm, thus increasing the paper bobbin cost and rendering the process industrially disadvantageous.

The flat compressive strength of the paper bobbin is an index of the collapsibility of the paper bobbin in the direction of its diameter, and it is measured by the following method. A preferred paper bobbin having a flat compressive strength of 1000-7000 (N) is one with a paper bobbin outer diameter of 5-15 cm, a paper bobbin thickness of 0.8-1.5 cm and a paper bobbin length of 7-30 cm. The most preferred type is one with a paper bobbin outer diameter of 10-13 cm, a paper bobbin outer thickness of 0.8-1.2 cm and a paper bobbin length of 17-22 cm.

In the production process of the invention, the paper bobbin as described above must be used for take-up with a contact area (compressed net area) S (cm²) of 240-1000 cm² between the paper bobbin and conjugate fiber, and the most preferred range for the compressed net area S is 550-880 cm².

The take-up speed must also be 2000-5000 m/min in the production process of the invention. A take-up speed of less than 2000 m/min will lower the industrial productivity. If the take-up speed is greater than 5000 m/min, a package tightening will tend to occur regardless of how the take-up conditions are adjusted, and it will therefore be impossible to obtain a conjugate fiber package wound weight of greater than 2 kg. The preferred take-up speed range is 2500-4500 m/min.

The paper bobbin used for the cheese package of the invention is preferably one that has been waterproofed and oilproofed on the surface. Waterproofing/oilproofing of the paper bobbin surface means using known parchment paper on the paper bobbin surface and/or coating the paper bobbin surface with a fluorine-based resin or the like having a waterproofing/oilproofing function.

When an aqueous emulsion type finishing agent is used on the conjugate fiber, it is important for the filament to exhibit both water resistance and oil resistance. From the viewpoint of exhibiting both water resistance and oil resistance, the paper bobbin preferably has a fluorine-based resin-coated parchment paper on the surface. Even more preferred from the viewpoint of exhibiting both water resistance and oil resistance is a paper bobbin having fluorine-based resin-coated parchment paper on the surface and a water-repellent sheet under it.

The waterproofing/oilproofing performance was evaluated based on the water absorption measured according to JIS-P-8140:1998. The water absorption is preferably no greater than 40 g/m²·15 min and more preferably no greater than 20 g/m²·15 min.

A more preferred mode of the production process of the invention will now be explained.

The winder may be a known type without any particular restrictions, and specifically it may be a traverse system such as a cam traverse system or multipede traverse system. It is preferred to use an automatic winder that actively drives the contact roll, with a circumferential speed ratio, i.e. overfeed, of 0-2% between the contact roll and the package, in order to lower the tension of the conjugate fiber just before it is taken up into the package.

In the production process of the invention, the tension To at the third heating roll exit point and the tension Ti at the traverse guide entrance point (winding tension) during take-up of the package are preferably controlled to within the ranges specified by the following formulas (3) and (4).

0≦Ti−To≦0.05 (cN/dtex) (Formula 3)

0.05<Ti≦0.20 (cN/dtex) (Formula 4)

As mentioned above, the conjugate fiber of the invention has internal stress which includes the stress produced by the winding tension when the filament is taken up into the package and the stress during drawing and heat treatment that has not been alleviated before the filament is taken up into the package. Thus, a high winding tension increases the internal stress of the package, resulting in package tightening and consequently poor form and poor reelability. On the other hand, if the tension of the yarn at the exit point of the final roll is lower than the stress of the yarn contacting the final roll, the yarn will tend to be taken up on (wound around) the roll.

In order to avoid this problem, the tension To at the third heating roll exit point and the tension Ti at the traverse guide entrance point (winding tension) are preferably controlled to satisfy the above Formulas 3 and 4 when the conjugate fiber is taken up.

If the winding tension Ti exceeds 0.20 cN/dtex, the internal stress of the package will increase, resulting in poor form and reelability due to package tightening and a reeling tension value (PPF) of greater than 100. On the other hand, if Ti−To exceeds 0.05 cN/dtex, the filament will tend to wrap around the final roll, resulting in yarn breakage. The preferred ranges are Ti−To≦0.02 cN/dtex and Ti≦0.10 cN/dTex.

The means for achieving the ranges specified by Formulas 3 and 4 may be, for example, eliminating the yarn guide of the interlacing nozzle between the final roll and the traverse guide of the winder, or employing a material with low friction resistance such as diamond-like carbon as the material of the yarn guide surface. The distance from the final roll exit point and the traverse guide may also be limited to no greater than 2 m to minimize air resistance.

Furthermore, in order to obtain a more satisfactory wound form of the cheese package for highly crimped conjugate fiber, the traverse angle may be increased from the inner to the middle layers and decreased from the middle to the surface layers, to produce “varying traverse angle winding”. In order to lower the reeling tension of the conjugate fiber at the inner core, it is most preferred for the traverse angle at a 1 mm winding thickness to be no greater than half the maximum traverse angle during take-up of the package.

When the conjugate fiber wound into a cheese package of the invention is used for a woven or knitted fabric, the total amount of fiber used may consist of the conjugate fiber, or it may be mixed with another fiber for use in part of the fabric. As other fibers to be mixed with the combined fiber there may be mentioned long and short fibers of polyester, cellulose, nylon-6, nylon-66, acetate, acryl, polyurethane elastic fibers, wool, silk and the like, although there is no limitation to these.

The woven or knitted fabric may also be produced from a combined fiber comprising the conjugate fiber wound on the cheese package of the invention and another fiber. A combined fiber may be produced by mixing and combining methods, including interlacing with another fiber, drawing/false twisting after interlacing, false twisting of either fiber followed by interlacing, separate false twisting of both the conjugate fiber and other fiber followed by interlacing, Taslan working of either fiber followed by interlacing, interlacing followed by Taslan working, or Taslan mixing. The combined fiber obtained by such methods preferably has a degree of intermingling of at least 10/m.

### EFFECT OF THE INVENTION

According to the invention, a conjugate fiber consisting of a plurality of single filament with different intrinsic viscosities, composed of PTT components consisting of at least 90 mol % of a trimethylene terephthalate unit and no more than 10 mol % of another ester repeating unit and laminated to each other in a side-by-side type, is taken up into a cheese package with a wound weight of 2 kg or greater and a satisfactory wound form.

The cheese package of the invention exhibits excellent effects, as it satisfactorily retains the form of the package even when exposed to high temperature for prolonged periods, and the conjugate fiber layered at the inner core of the package has satisfactory reelability and no dyeing color differences. The conjugate fiber has high crimp expression even when used in a high-density fabric with a cover factor of 2000-4000.

### BRIEF DESCRIPTION OF THE DRAWINGS

FIG. 1a is a schematic view showing an example of the “peanut” single filament cross-section of a conjugate fiber wound into a cheese package.

FIG. 1b is a schematic view showing an example of the “snowman” single filament cross-section of a conjugate fiber wound into a cheese package.

FIG. 2 shows the relationship between the contact area (compressed net area) S (cm²) between the paper bobbin and conjugate fiber and the wound weight W (kg).

FIG. 3 shows the results of measuring the reeling tension value for an example with a low reeling tension value and satisfactory reelability.

FIG. 4 shows the results of measuring the reeling tension value for an example with a high reeling tension value and poor reelability.

FIG. 5 is a schematic view showing an example of a composite spinning apparatus used for the production process of the invention.

FIG. 6a is a schematic view showing a method for measurement of the flat compressive strength of a paper bobbin. In this drawing, b represents the paper bobbin.

FIG. 6b is a drawing of an example of a load-deformation curve. W (vertical axis) is the load, L (horizontal axis) is the displacement and k is the primary yield point.

FIG. 7 is a drawing showing a method used to calculate the winding volume necessary for calculating the package density. Here, “a” represents the conjugate fiber and “b” represents the paper bobbin.

### EXPLANATION OF SYMBOLS

1 Polymer drier
2 Extruder
3 Polymer drier
4 Extruder
5 Bend
6 Bend
7 Spin head
8 Spin pack
9 Spinneret
10 Conjugate fiber
11 Non-blast zone
12 Cooling air
13 Finishing agent application nozzle
14 First roll
15 Second roll
16 Third roll
17 PTT conjugate fiber package
18 Interlacing nozzle

### BEST MODE FOR CARRYING OUT THE INVENTION

The present invention will now be described in greater detail by examples, with the implicit understanding that the invention is not limited in any way by the examples.

The measuring and evaluating methods were as follows.

### (1) Intrinsic Viscosity

The intrinsic viscosity [η] is the value defined by the following formula.

$$[ η ] = {lim}_{C \to 0} ( η r - 1 ) / C \qquad [ Formula 1 ]$$

In this formula, ηr is the value of the viscosity of a dilute solution of the PTT polymer in ≧98% purity o-chlorophenol at 35° C., divided by the viscosity of the solvent measured at the same temperature, and it is defined as a relative viscosity. C is the polymer concentration represented as g/100 ml.

### (2) Flatness of Single Filament of Conjugate Fiber

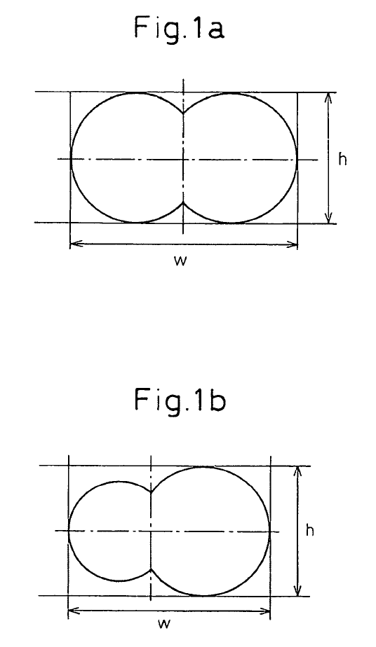

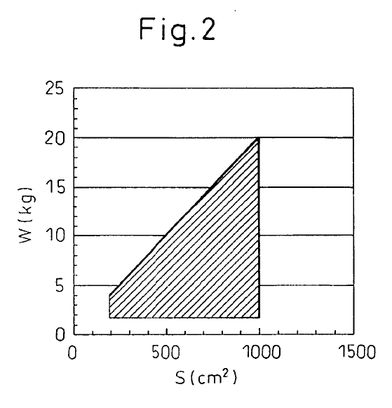

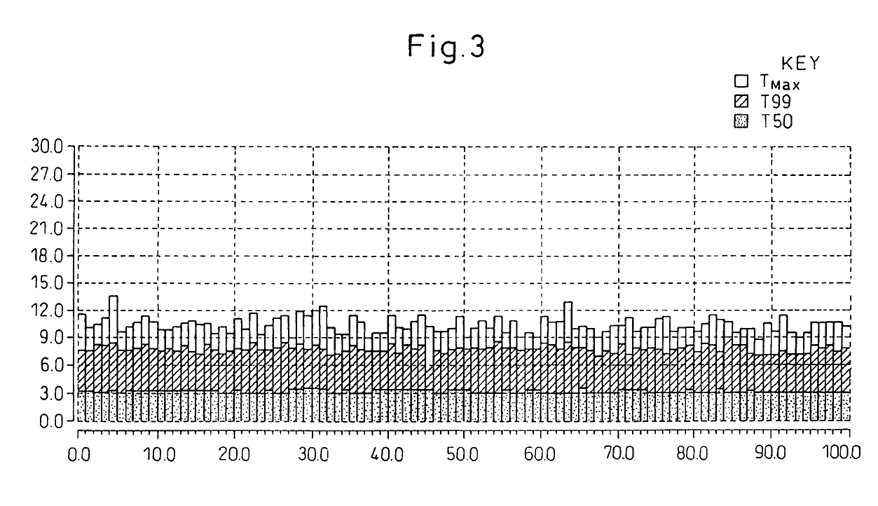

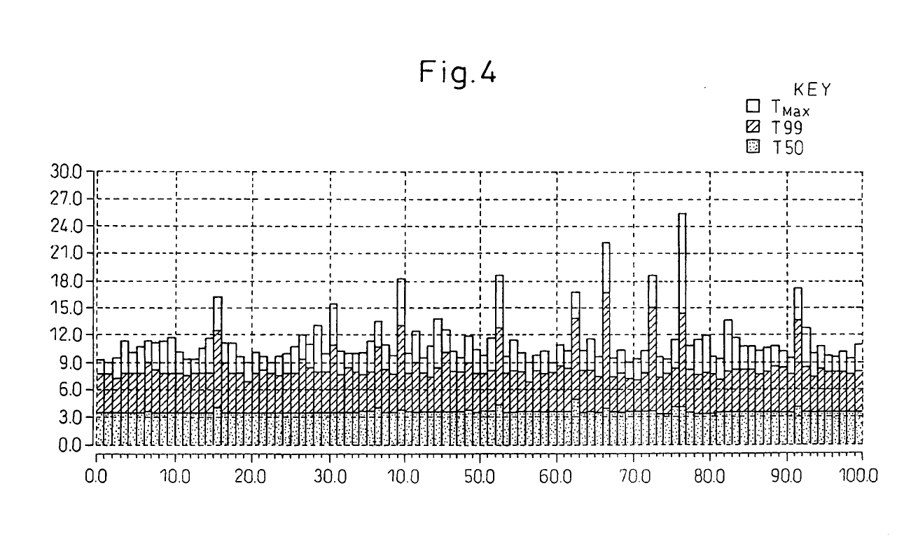

A cross-section of the conjugate fiber was photographed and the flatness of the single filament was calculated according to FIG. 1a or FIG. 1b.

Flatness=w/h

The flatness was calculated for each single filament of all the single filaments of the conjugate fiber and the average value was calculated.

### (3) Developed Crimp Elongation

The conjugate fiber was taken up on a hank 10 times using a sizing reel with a circumference of 1.125 m and allowed to stand until the next day without tension in a steady temperature and humidity room according to JIS-L-1013.

Tension was then applied to the hank, the hank length was measured, and the developed crimp elongation was determined by the following formula.

Developed crimp elongation (%)=[(L2−L1)/L1]×100

L1=Hank length with a tension of 1×10⁻³ cN/dtex

L2=Hank length with a tension of 0.18 cN/dtex

### (4) Compressed Net Area S

The contact area (compressed net area) S (cm²) between the paper bobbin and conjugate fiber was calculated by the following formula from the outer diameter D (cm) of the paper bobbin on which the conjugate fiber was wound and the mechanical traverse width L (cm) of the winder.

S=π×D×L

### (5) Package Density

The wound weight of the cheese package (minus the weight of the paper bobbin) W (kg) was divided by the wound volume (cm³) of the package.

Package density=W×1000/wound volume

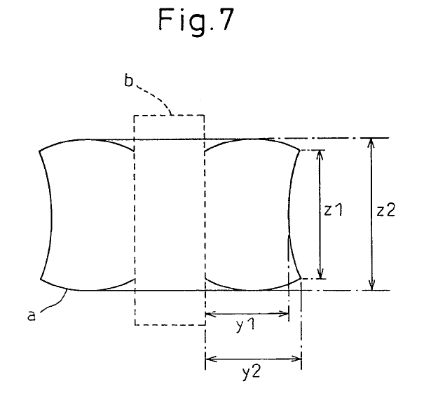

Calculation of the wound weight will now be explained with reference to FIG. 7.

The mean wound width z (cm²) and the mean wound thickness y (cm²) of the cheese package were calculated by the following formulas.

z=(z1+z2)/2

y=(y1+y2)/2

The wound volume (cm³) was calculated as follows, with D (cm) as the paper bobbin outer diameter.

Wound volume=π×{(y+D/2)²−(D/2)²}×z

(6) Crimp Elongation after Dry Heat Treatment

The conjugate fiber was taken up on a hank 10 times using a sizing reel with a circumference of 1.125 m and subjected to heat treatment for 30 minutes in a thermostatic bath at a temperature of 90±2° C. while under tension of 0.9×10⁻² cN/dtex. After treatment, it was allowed to stand until the next day without tension in a steady temperature and humidity room according to JIS-L-1013. Tension was then applied to the hank, the hank length was measured, and the crimp elongation was determined by the following formula.

Crimp elongation (%)=(L4−L3)/L3×100

L3=Hank length with a tension of 1×10⁻³ cN/dtex

L4=Hank length with a tension of 0.18 cN/dtex

### (7) Reeling Tension Value (PPF)

For measurement of the reeling tension value (PPF), the package was heat treated under the following conditions.

Oven: LHU113 (product of Espec Corp.)

### Temperature: 45±2° C.

### Humidity: 65±3% RH

Time: 24 hours

The reeling tension value (PPF) was measured under the following conditions using a Package Performance

### Analyzer: (PPA3) by Rieter-Scragg, Ltd.

Reeling speed: 600 m/min
Reeled filament length: 2000 m

The reeling tension value (PPF) used was the value calculated automatically by the analyzer (PPA3), with measurement under the conditions described above.

### (8) Percentage Reduction of Finishing Agent

The deposit efficiency of the finishing agent was measured according to JIS-L-1013, subtracting the weight of the filament. The cheese package was measured after being dry heat treated at 45±2° C. for 24 hours.

The conjugate fiber was taken up on a hank to a weight of 1 g using a sizing reel with a circumference of 1.125 m, and after precisely determining the weight (filament weight), the conjugate fiber was washed with diethyl ether, the diethyl ether was distilled off and the weight was again precisely measured (weight after removal). This value was used to determine deposit efficiency of the finishing agent from the ratio of the amount of net finishing agent adhering to the filament surface divided by the filament weight, and the percentage reduction of the finishing agent was calculated.

Finishing agent deposit efficiency (%)=[(Fiber weight−weight after removal)]/fiber weight)×100

Percentage reduction of finishing agent (%)=[(WT−W1)/WT]×100

WT is the deposit efficiency of the finishing agent on 1 g of filament at the surface.

W1 is the deposit efficiency of the finishing agent on 1 g of filament at the inner core.

### (9) Water Absorption of Paper Bobbin Surface

The water absorption of the paper bobbin surface was measured according to JIS-P-8140:1998. Evaluation was conducted using a sample of the paper bobbin surface cut to a size of 30 mm×30 mm and the 20 wt % aqueous emulsion used for the conjugate fiber as the contact liquid, with a liquid contact time of 15 minutes. A water absorption of up to 40 g/m²·15 min was judged to be satisfactory water/oil resistance.

(10) Fineness, Breaking Strength, Ductility and Boiling water shrinkage ratio

These were measured according to JIS-L-1013.

### (11) Shrinkage Factor

A conjugate fiber cheese package with the prescribed wound weight taken up with a winder was immediately carried to a laboratory with standard conditions according to JIS-L-0105. The conjugate fiber was immediately removed from the cheese package and then the top end was anchored with a clip and an initial tension (0.05 cN/dTex) was applied while striking at two points at a precise 500 mm spacing. This procedure was carried out within 15 minutes after taking the conjugate fiber up into the cheese package.

The filament was then allowed to stand until the next day with the initial tension applied, and then the length between the two points was measured (L5) and the shrinkage factor was calculated by the following formula.

Shrinkage factor (%)=(500−L5)/500×100

### (12) Flat Compressive Strength of Paper Bobbin

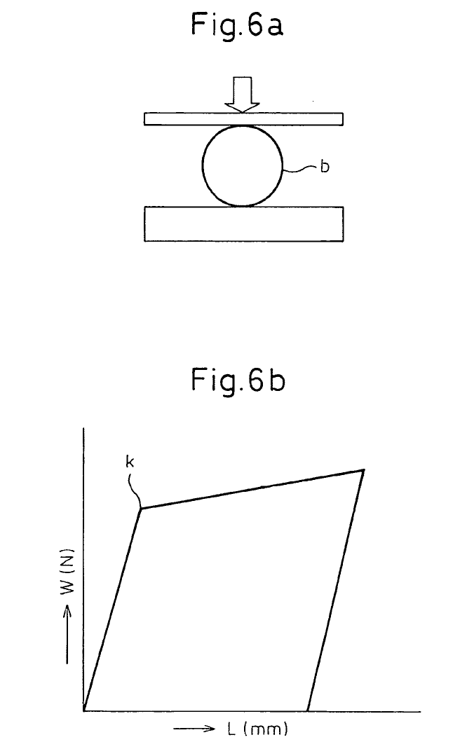

This was measured according to JIS-L-6417:1982. The measurement was carried out by a compression test with application of force in the direction of the paper bobbin diameter using a tool as shown in FIG. 6a. The compression speed was 30 mm/min. The primary point of inflection (yield point) was read from the obtained load-deformation curve shown in FIG. 6b as the flat compressive strength.

### (13) Tensile Force

The tensile force was measured using a Min Tens R-046 (Rothschild Corp.) as the tensiometer, to determine the value as indicated by the tensiometer (cN) for the running filament, and this was divided by the fineness D (dtex) of the filament to determine the winding tension and the tensile force at the final roll exit point.

Tensile force (cN/dtex)=[Value indicated by tensiometer]/D

Ti is the tensile force at the traverse guide entrance point (winding tension)

To is the tensile force at the final roll exit point.

### (14) Extreme Stress and Extreme Temperature for Dry Heat Shrinkage

A thermal stress measuring apparatus (trade name: KE-2S by Kanebo Engineering Co.) was used for the measurement.

The conjugate fiber (fineness as D (dtex)) was cut to a length of approximately 20 cm, and the ends were tied together to form an approximately 8 cm-long ring which was placed in the measuring device. Measurement was performed with an initial tension of 0.05 cN/dtex and a temperature-elevating rate of 100° C./min, and the temperature change for the thermal stress was marked on a chart. The thermal stress follows a bell curve in the high temperature range. The extreme stress was recorded as the value determined by the following formula from the value (cN) read for the peak of the bell curve. The temperature at the peak was recorded as the extreme temperature.

Extreme stress (cN/dtex)=[(value read for peak: cN)/(D×2)]−(initial tension: cN/dtex)

### (15) Package Tightening and Spinning Stability

A melt spinning machine with a 6-end spinneret per spindle was used for 2 days of melt spinning and drawing/take-up for each example.

Occurrence of package tightening during this period, and the number of yarn breaks and occurrence of fluff in the obtained conjugate fiber cheese package (the proportion of the number of packages with fluff) were judged in the following manner.

### (Package Tightening)

Good: No package tightening and no deformation of package form.
Poor: Package tightening or deformation of package form.

### (Evaluation of Yarn Breakage and Fluff)

Very good: No yarn breaks, fluff package proportion: ≦5%.
Good: ≦2 yarn breaks, fluff package proportion: <10%.
Poor: ≧3 yarn breaks, fluff package proportion: ≧10%.

### (16) Dyeing Quality (Surface/Core Color Difference, Dyeing Spots)

The inner core and outermost layer sections of the conjugate fiber cheese package were tail-tied and single-loop knitted with a seamless knitting machine, scoured and dyed, and then evaluated for quality.

The dyeing was carried out under the following conditions and followed by drying before judging the quality.

The dyeing spots were graded on a level of 0-10, with 8 and higher being acceptable.

The color difference (with (NBS)) was determined by visually judging the dyeing density at the core and outermost layer on a scale of 0-3 in steps of 0.5, with a color difference of up to 1.0 being judged as acceptable.

### Dye: FORON NAVY S-2GL 200 (Clariant Japan)

Dyeing density: 0.5% omf
Liquor to goods ratio: 1:18
Dyeing temperature: 100° C.
Dyeing time: 1 hour

### (Evaluation)

Very good: No defects such as dyeing spots or color difference, very satisfactory.
Good: No defects such as dyeing spots or color difference, satisfactory.
Poor: Dyeing spots or color difference, unsatisfactory.

### (17) Stretch Performance

The stretch property of a fabric comprising the conjugate fiber was evaluated. The fabric was prepared in the following manner.

A plain weave fabric was prepared using an untwisted starched yarn of the 84 dtex/24f PTT fiber SOLOTEX™ (Solotext Co., Ltd.) as the warp yarn and a PTT conjugate fiber of an example of comparative example of the invention as the weft yarn.

Warp density: 97 strands/2.54 cm
Weft density: 88 strands/2.54 cm

### Loom: ZW-303 Water Jet Loom by Tsudakoma Corp.

Weaving speed: 450 rpm

The obtained greige was subjected to relax scouring at 95° C. with a jet relaxer, and dyeing was performed at 120° C. using a jet dyeing machine. It was then finished at 170° C. and subjected to a series of treatments for tentering and heat setting. The warp/weft density of the finished fabric was as follows.

Warp density: 160 strands/2.54 cm
Weft density: 93 strands/2.54 cm

The cover factor of the obtained fabric was 2660.

The fabric was evaluated in terms of stretch factor and recovery factor by the following method.

Using a tensile tester by Shimadzu Corp. with a grip width of 2 cm, a grip spacing of 10 cm and a pull rate of 10 cm/min, the sample was stretched in the weft direction and the elongation (%) under a stress of 2.94 N/cm was recorded as the stretch factor.

It was then allowed to contract to a grip spacing of 10 cm at the same rate, and a stress-strain curve was drawn and the ductility until stress was exhibited was recorded as the residual elongation (A). The recovery factor was determined by the following formula.

Recovery factor=[(10−A)/10]×100%

The stretch performance was judged as follows, based on the measured stretch factor and recovery factor.

Very good: Stretch performance of >20%, recovery factor of >85%.
Good: Stretch performance of 10-20%, recovery factor of 80-85%.
Poor: Stretch performance of <10%, recovery factor of <80%.

### (18) Overall Evaluation

The reelability, dyeing quality and stretch performance were comprehensively judged on the following scale.

Very good: Very satisfactory reelability, dyeing quality and stretch performance.
Good: An evaluation of “Good” for at least one property among the reelability, dyeing quality and stretch performance, with “Very good” for the other two.
Poor: An evaluation of “Poor” for the reelability, processability or dyeing quality.

### EXAMPLES 1-4

### Comparative Examples 1 and 2

These examples demonstrated the effects of varying the roll speed, breaking elongation and shrinkage factor during production on the physical properties of the conjugate fiber, the reelability of the cheese package, the dyeing quality (surface/core color difference) and the fabric stretch performance.

The production conditions for Example 1 were as follows.

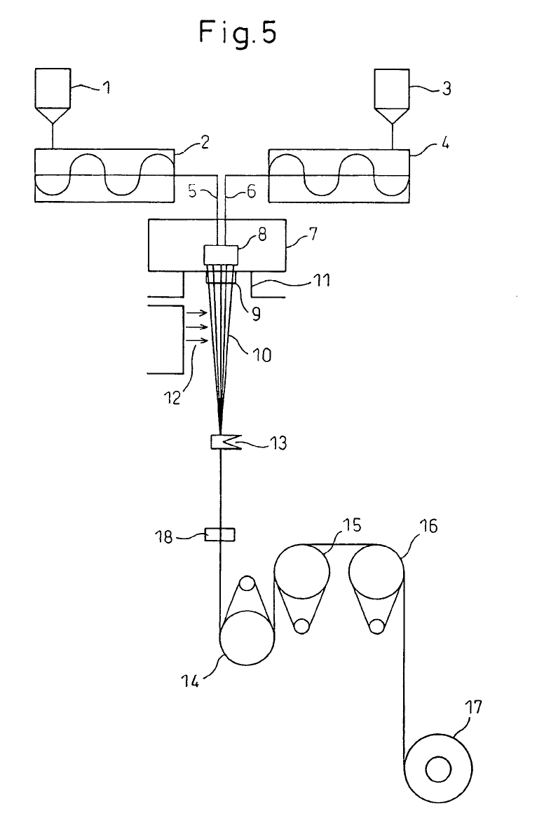

PTT with an intrinsic viscosity of 1.26 dl/g containing 0.4 wt % titanium oxide as one component and PTT with an intrinsic viscosity of 0.92 dl/g containing 0.4 wt % titanium oxide as the other component were used to produce a PTT conjugate fiber cheese package with 167 dtex/48 filaments under the following conditions, using a composite spinning apparatus as shown in FIG. 5.

### (Spinning Conditions)

Pellet drying temperature and maximum moisture content: 110° C., 15 ppm.
Extruder temperature: 255° C. on A-shaft, 250° C. on B-shaft.
Spin head temperature: 265° C.
Spinneret: Nozzle having pairs of holes with pore sizes of 0.30 mmΦ formed at a spacing of 0.2 mm, with 48 holes per nozzle.
High intrinsic viscosity component/low intrinsic viscosity component ratio: 40/60 (wt %)
Cooling air conditions: Temperature: 22° C., relative humidity: 90%, speed 0.4 m/sec.
Finishing agent: Aqueous emulsion composed mainly of polyether ester (concentration: 20 wt %, finishing agent coating: 0.7 wt %)
Distance from spinneret to finishing agent spray nozzle: 75 cm

### (Take-Up Conditions)

First roll: Speed: 2500 m/min, Temperature: 55° C.
Second roll: Speed listed in Table 1, Temperature: 130° C.
Third roll: Speed listed in Table 1, Temperature: 110° C.
Third roll-traverse guide distance: 1.5 m
Winder: AW-909 (Product of TMT Machinery, Inc., automatic driving of both bobbin shaft and contact roll shaft)
Overfeed rate: 0.5%
Traverse angle: The traverse angle was varied in the following manner for different winding thicknesses.
Winding thickness: 0-1 mm, 4.0 degrees
Winding thickness: 40-60 mm, 8.8 degrees
Winding thickness: 100-120 mm, 6.0 degrees
Package temperature during take-up: 25° C.
Paper bobbin: Length: 25 cm, thickness: 0.9 cm, outer diameter: 11.2 cm

The paper bobbin used comprised parchment paper on the paper bobbin surface coated with a fluorine-based resin (INT-330: Tokyo Sangyo Yoshi Co., Ltd.). The water absorption of the paper bobbin was 5 g/m²·15 min, and the flat compressive strength was 5370 N.

The physical properties of the obtained cheese package and conjugate fiber were as follows.

### (Cheese Package)

Wound diameter: 240 cm
Wound width: 19 cm
Wound weight: 6.0 kg
Compressed net area S: 669 cm²

### (Physical Properties of Conjugate Fiber)

Filament intrinsic viscosity: 1.1 dl/g
Fineness: 167 dtex
Single filament cross-section and flatness: Snowman shape, flatness: 1.7 (shown in FIG. 1)
Finishing agent percentage reduction for 1 part by weight at core: 5%

The physical properties and evaluation results for the obtained conjugate fiber and cheese package are shown in Tables 1 and 2.

For Examples 2-4 and Comparative Examples 1 and 2, conjugate fiber cheese packages were produced under the same conditions as in Example 1, except for using the roll speeds listed in Tables 1 and 2. The physical properties and evaluation results for the conjugate fibers and cheese packages obtained in the examples and comparative examples are shown in Tables 1 and 2.

As can be seen from Tables 1 and 2, the conjugate fibers and cheese packages according to the examples of the invention had excellent stretch properties and form retention, as well as satisfactory reelability and dyeing quality at the core (color difference between surface and core).

Comparative Example 1 had low breaking elongation and a high shrinkage factor outside of the ranges specified by the invention, and as a result a package tightening occurred and the effect of the invention in terms of reelability and dyeing quality (color difference between surface and core) was not exhibited.

Comparative Example 2 had high breaking elongation outside of the range specified by the invention, and as a result the crimp performance of the conjugate fiber was insufficient and the effect of the invention in terms of fabric stretch property was not exhibited.

### EXAMPLES 5-7

### Comparative Examples 3 and 4

These examples demonstrate the effect of the cross-sectional shape of the single filament composing the conjugate fiber cheese package.

PTT conjugate fiber having cross-sectional shapes with different flatnesses was obtained using different spinning hole shapes for spinning, drawing and take-up in the same manner as Example 2.

The physical properties and evaluation results for the conjugate fibers and cheese packages obtained in the examples are shown in Table 3.

As can be seen from Table 3, the conjugate fibers and cheese packages according to the examples of the invention had excellent stretch performance and form retention, as well as satisfactory reelability and dyeing quality at the core (color difference between surface and core).

Comparative Example 3 had a low degree of flatness outside of the range specified by the invention, and as a result the crimp performance of the conjugate fiber was insufficient and the effect of the invention in terms of fabric stretch property was not exhibited.

Comparative Example 4 had a high degree of flatness outside of the range of the invention, and as a result the dyeing quality of the fabric was poor (shininess due to glossy spots) and the effect of the invention was not exhibited.

### EXAMPLES 8 AND 9

### Comparative Examples 5 and 6

These examples demonstrate the effect of the shrinkage factor during take-up of the conjugate fiber cheese package.

The third roll temperature and relaxation ratio were changed for spinning, drawing and take-up in the same manner as Example 2, to obtain conjugate fiber having different shrinkage factors.

The physical properties and evaluation results for the conjugate fibers and cheese packages obtained in the examples are shown in Table 4.

As can be seen from Table 4, the conjugate fibers and cheese packages according to the examples of the invention had excellent stretch properties and form retention, as well as satisfactory reelability and dyeing quality at the core (color difference between surface and core).

Comparative Example 5 had a high shrinkage factor outside of the range specified by the invention, and as a result a package tightening occurred and the effect of the invention in terms of reelability and dyeing quality (color difference between surface and core) was not exhibited.

Comparative Example 6 had a low shrinkage factor outside of the range specified by the invention, and as a result the crimp performance of the conjugate fiber was insufficient and the effect of the invention in terms of fabric stretch property was not exhibited.

### EXAMPLES 10-12

### Comparative Examples 7 and 8

These examples demonstrate the effects of the flat compressive strength of the paper bobbin and the contact area (compressed net area) between the paper bobbin and conjugate fiber.

The winder used (wound width, paper bobbin outer diameter) and type of paper bobbin (paper bobbin thickness and flat compressive strength) were changed for take-up with spinning and drawing under the same conditions as in Example 2.

The physical properties and evaluation results for the conjugate fibers and cheese packages obtained in the examples are shown in Table 5.

As can be seen from Table 5, the conjugate fibers and cheese packages according to the examples of the invention had excellent stretch properties and form retention, as well as satisfactory reelability and dyeing quality at the core (color difference between surface and core).

Comparative Example 7 had low flat compressive strength outside of the range specified by the invention, and as a result a package tightening occurred and the effect of the invention in terms of reelability and dyeing quality (color difference between surface and core) was not exhibited.

Comparative Example 8 had a high compressed net area outside of the range specified by the invention, and as a result the effect of the invention in terms of reelability was not exhibited.

### EXAMPLES 13 AND 14

### Comparative Examples 9-11

These examples demonstrate the effect of the wound weight during take-up of the conjugate fiber cheese package.

The take-up time onto the paper bobbin was changed for spinning, drawing and take-up in the same manner as Example 2, to obtain cheese packages with different wound weights for Examples 13 and 14 shown in Table 6.

As comparative examples, the follow-up test of Example 9 described in Patent document 1 was carried out to obtain conjugate fiber cheese packages with different wound weights for Comparative Examples 9-11 shown in Table 6.

The production conditions for Comparative Examples 9-11 were as follows.

PTT with an intrinsic viscosity of 1.2 dl/g containing 0.4 wt % titanium oxide as one component and PTT with an intrinsic viscosity of 0.65 dl/g containing 0.4 wt % titanium oxide as the other component were used to produce a conjugate fiber cheese package with 165 dtex/12 filaments, using a composite spinning apparatus as shown in FIG. 5. However, the conjugate fiber was taken up into a package with a winder directly from the second roll, without passing through the third roll.

The spinning conditions for Comparative Examples 9-11 were as follows.

### (Spinning Conditions)

Polymer drying temperature and maximum moisture content: 110° C., 15 ppm.
Extruder temperature: 255° C. on A-axis, 250° C. on B-axis.
Spin head temperature: 260° C.
Spinneret: Nozzle having pairs of holes with pore sizes of 0.30 mmΦ formed at a spacing of 0.2 mm, with 12 holes per nozzle.
High intrinsic viscosity component/low intrinsic viscosity component ratio: 50/50 (wt %)
Cooling air conditions: Same as Example 2
Finishing agent: Same as Example 2
Distance from spinneret to finishing agent spray nozzle: 95 cm

### (Take-Up Conditions)

First roll: Speed: 1100 m/min, Temperature: 70° C.
Second roll: Speed: 3960 m/min, Temperature: 150° C.
Third roll-traverse guide distance: 1.5 m

### Winder: Same as Example 2

Take-up speed: 3762 m/min
Package temperature during take-up: 25° C.
Paper bobbin: Same as Example 2

### (Physical Properties of Conjugate Fiber)

Filament intrinsic viscosity: 0.9 dl/g
Fineness: 167 dtex
Single filament cross-section and flatness: Peanut shape, flatness: 1.7 (shown in FIG. 1a)

As can be seen from Table 6, the conjugate fibers and cheese packages according to Examples 13 and 14 of the invention had excellent stretch properties and form retention, as well as satisfactory reelability and dyeing quality at the core (color difference between surface and core).

Comparative Example 9 had satisfactory reelability and dyeing quality (color difference between surface and core) with a wound weight of 0.1 kg.

However, Comparative Examples 10 and 11 resulted in package tightening with a wound weight of 2.0 kg or greater and had poor wound forms, reelability and dyeing quality.

Comparative Examples 10 and 11 had high shrinkage factors outside of the ranges specified by the invention, and as a result a package tightening occurred and the effect of the invention in terms of reelability and dyeing quality (color difference between surface and core) was not exhibited.

### EXAMPLES 15-17

### Comparative Example 12

These examples demonstrate the effects of the intrinsic viscosities of the high intrinsic viscosity component and low intrinsic viscosity component, and the difference in their intrinsic viscosities.

Spinning and take-up were carried out with different intrinsic viscosities of the polymer for spinning, drawing and take-up under the same conditions as in Example 2.

The physical properties and evaluation results for the conjugate fibers and cheese packages obtained in the examples are shown in Table 7.

As can be seen from Table 7, the conjugate fibers and cheese packages according to the examples of the invention had excellent stretch properties and form retention, as well as satisfactory reelability and dyeing quality at the core (color difference between surface and core).

Comparative Example 12 had a small difference in intrinsic viscosity outside of the range specified by the invention, and as a result the crimp performance of the conjugate fiber was insufficient and the effect of the invention in terms of fabric stretch property was not exhibited.

### EXAMPLES 18 AND 19

These examples demonstrate the effects of the traverse angle at a cheese package wound thickness of 1 mm on the reeling tension value during take-up of the conjugate fiber.

Cheese packages were obtained with different flatnesses for the cross-sectional shape of the single filament in the conjugate fiber, and different traverse angles at a wound thickness of 0-1 mm, with spinning, drawing and take-up in the same manner as Example 2. The reeling tension values for the obtained conjugate fibers and cheese packages are shown in Table 8.

TABLE 1

| | | | Example | Example | Example | Example |
|---|---|---|---|---|---|---|
| | | | 1 | 2 | 3 | 4 |
| First roll speed | | m/min | 2000 | 2500 | 3000 | 2500 |
| Second roll speed | | m/min | 2760 | 3220 | 3320 | 3020 |
| Third roll speed | | m/min | 2810 | 3220 | 3300 | 3020 |
| Take-up speed | | m/min | 2760 | 3150 | 3250 | 2980 |
| Stretch factor | | | 1.38 | 1.29 | 1.16 | 1.21 |
| Tension ratio | | | 1.02 | 1.00 | 0.99 | 1.00 |
| Ti-To | | cN/dtex | 0.06 | 0.03 | 0.03 | 0.04 |
| Ti | | cN/dtex | 0.08 | 0.06 | 0.05 | 0.05 |
| Breaking elongation | | % | 28 | 30 | 38 | 35 |
| Shrinkage factor | | % | 1.0 | 0.8 | 0.6 | 0.6 |
| Spinning stability | | Package | Very | Very | Very | Very |
| | | tightening | good | good | good | good |
| | | Yarn | Very | Very | Good | Very |
| | | breakage, | good | good | | good |
| | | fluff | | | | |
| Flatness | | | 1.7 | 1.7 | 1.7 | 1.2 |
| Developed crimp | | % | 152 | 121 | 83 | 30 |
| elongation | | | | | | |
| Crimp elongation | | % | 20 | 15 | 9 | 4 |
| after dry heat | | | | | | |
| treatment | | | | | | |
| Package density | | g/cm³ | 1.01 | 0.98 | 0.92 | 0.92 |
| Reeling tension value | | | 61 | 46 | 58 | 64 |
| Percentage reduction | | % | 5 | 5 | 5 | 5 |
| of finishing agent | | | | | | |
| Dry heat | Extreme | cN/dtex | 191 | 195 | 210 | 208 |
| shrinkage | temperature | | | | | |
| | Extreme | cN/dtex | 0.15 | 0.13 | 0.09 | 0.09 |
| | stress | | | | | |

| | | | | |
|---|---|---|---|---|
| Dyeing quality | Very | Very | Very | Good |
| | good | good | good | |
| Fabric stretch | Very | Very | Good | Good |
| property | good | good | | |
| Overall evaluation | Very | Very | Good | Good |
| | good | good | | |

TABLE 2

| | | Comp. | Comp. |
|---|---|---|---|
| | | Ex. 1 | Ex. 2 |
| First roll speed | m/min | 2500 | 2500 |
| Second roll speed | m/min | 3900 | 2900 |
| Third roll speed | m/min | 3850 | 2900 |
| Take-up speed | m/min | 3820 | 2860 |
| Stretch factor | | 1.54 | 1.16 |
| Tension ratio | | 0.99 | 1.00 |
| Ti-To | cN/dtex | 0.07 | 0.02 |
| Ti | cN/dtex | 0.25 | 0.04 |
| Breaking elongation | % | 22 | 49 |
| Shrinkage factor | % | 2.0 | 0.2 |
| Spinning stability | Package | Poor | Very |
| | tightening | | good |
| | Yarn | Poor | Good |
| | breakage, | | |
| | fluff | | |
| Flatness | | 1.8 | 1.5 |
| Developed crimp | % | 250 | 25 |
| elongation | | | |
| Crimp elongation | % | 32 | 2 |
| after dry heat | | | |
| treatment | | | |
| Package density | g/cm³ | 1.11 | 0.85 |
| Reeling tension value | | 185 | 40 |
| Percentage reduction | % | 5 | 5 |
| of finishing agent | | | |

| | | | | |
|---|---|---|---|---|
| Dry heat | Extreme | cN/dtex | 180 | 226 |
| shrinkage | temperature | | | |
| | Extreme | cN/dtex | 0.25 | 0.04 |
| | stress | | | |

| | | |
|---|---|---|
| Dyeing quality | Poor | Good |
| Fabric stretch | Very | good |
| property | good | |
| Overall evaluation | Poor | Poor |

TABLE 3

| | | | Example | Example | Example | Comp. | Comp. |
|---|---|---|---|---|---|---|---|
| | | | 5 | 6 | 7 | Ex. 3 | Ex. 4 |
| Flatness | | | 1.2 | 2.2 | 2.8 | 0.1 | 4.0 |
| Breaking elongation | | % | 30 | 29 | 29 | 30 | 29 |
| Shrinkage factor | | % | 0.8 | 0.8 | 0.8 | 0.8 | 0.8 |
| Spinning stability | | Package | Very | Very | Very | Very | Very |
| | | tightening | good | good | good | good | good |
| | | Yarn | Very | Very | Good | Very | Poor |
| | | breakage, | good | good | | good | |
| | | fluff | | | | | |
| Developed crimp | | % | 121 | 155 | 178 | 5 | 206 |
| elongation | | | | | | | |
| Crimp elongation after | | % | 11 | 18 | 19 | 2 | 21 |
| dry heat treatment | | | | | | | |
| Package density | | g/cm³ | 1.00 | 0.96 | 0.94 | 0.91 | 0.89 |
| Reeling tension value | | | 48 | 60 | 60 | 58 | 102 |
| Dry heat | Extreme | cN/dtex | 195 | 198 | 198 | 205 | 185 |
| shrinkage | temperature | | | | | | |
| | Extreme | cN/dtex | 0.13 | 0.12 | 0.12 | 0.12 | 0.16 |
| | stress | | | | | | |

| | | | | | |
|---|---|---|---|---|---|
| Dyeing quality | Very | Very | Very | Good | Poor |
| | good | good | good | | |
| Fabric stretch | Good | Very | Good | Poor | Good |
| property | | good | | | |
| Overall evaluation | Good | Very | Good | Poor | Poor |
| | | good | | | |

TABLE 4

| | | | | | Comp. | Comp. |
|---|---|---|---|---|---|---|
| | | | Example 8 | Example 9 | Ex. 5 | Ex. 6 |
| Third roll temperature | | ° C. | 60 | 150 | 30 | 180 |
| Relaxation ratio | | % | 2.5 | 0.2 | 0.0 | 0.5 |
| Breaking elongation | | % | 29 | 31 | 28 | 35 |
| Shrinkage factor | | % | 1.0 | 0.8 | 2.0 | 0.1 |
| Spinning stability | | Package | Very | Very | Poor | Very |
| | | tightening | good | good | | good |
| | | Yarn | Very | Good | Good | Poor |
| | | breakage, | good | | | |
| | | fluff | | | | |
| Developed crimp | | % | 158 | 98 | 254 | 4 |
| elongation | | | | | | |
| Crimp elongation after | | % | 17 | 9 | 32 | 3 |
| dry heat treatment | | | | | | |
| Package density | | g/cm³ | 1.05 | 0.96 | 1.11 | 0.84 |
| Reeling tension value | | | 62 | 50 | 112 | 102 |
| Dry heat | Extreme | cN/dtex | 190 | 198 | 160 | 220 |
| shrinkage | temperature | | | | | |
| | Extreme | cN/dtex | 0.15 | 0.12 | 0.24 | 0.04 |
| | stress | | | | | |

| | | | | |
|---|---|---|---|---|
| Dyeing quality | Very | Very | Poor | Good |
| | good | good | | |
| Fabric stretch | Very | Good | Good | Poor |
| property | good | | | |
| Overall evaluation | Very | Good | Poor | Poor |
| | good | | | |

TABLE 5

| | | Example | Example | Example | Comp. | Comp. |
|---|---|---|---|---|---|---|
| | | 10 | 11 | 12 | Ex. 7 | Ex. 8 |
| Paper bobbin | cm | 11.0 | 11.8 | 12.8 | 9.7 | 12.8 |
| diameter | | | | | | |
| Paper bobbin | mm | 10 | 12 | 7 | 4 | 7 |
| thickness | | | | | | |
| Wound width | cm | 7 | 19 | 24 | 7 | 32 |
| Compressed net | cm² | 212 | 704 | 965 | 213 | 1287 |
| area S | | | | | | |
| Flat compressive | N | 1100 | 5880 | 5370 | 800 | 5370 |
| strength of paper | | | | | | |
| bobbin | | | | | | |
| Wound weight | Kg | 4.0 | 6.0 | 12.0 | 2.0 | 6.0 |
| Breaking | % | 30 | 30 | 30 | 31 | 30 |
| elongation | | | | | | |
| Shrinkage factor | % | 0.8 | 0.8 | 0.8 | 0.8 | 0.8 |
| Spinning | Package | Very | Very | Very | Poor | Very |
| stability | tightening | good | good | good | | good |
| | Yarn | Very | Very | Very | Good | Good |
| | breakage, | good | good | good | | |
| | fluff | | | | | |
| Developed crimp | % | 121 | 121 | 121 | 121 | 121 |
| elongation | | | | | | |
| Crimp elongation | % | 15 | 15 | 15 | 15 | 15 |
| after dry heat | | | | | | |
| treatment | | | | | | |
| Reeling tension | | 42 | 40 | 88 | 132 | 220 |
| value | | | | | | |
| Dyeing quality | | Very | Very | Very | Poor | Poor |
| | | good | good | good | | |
| Fabric stretch | | Very | Very | Very | Good | Good |
| property | | good | good | good | | |
| Overall | | Very | Very | Good | Poor | Poor |
| evaluation | | good | good | | | |

TABLE 6

| | | | Example | Example | Comp. | Comp. | Comp. |
|---|---|---|---|---|---|---|---|
| | | | 13 | 14 | Ex. 9 | Ex. 10 | Ex. 11 |
| Package weight | | Kg | 3.0 | 12.0 | 0.1 | 2.0 | 6.0 |
| First roll speed | | m/min | 2500 | 2500 | 1100 | 1100 | 1100 |
| Stretch factor | | | 1.29 | 1.29 | 3.60 | 3.60 | 3.60 |
| Relaxation ratio | | % | 2.2 | 2.2 | 5.0 | 5.0 | 5.0 |
| Ti | | cN/dtex | 0.06 | 0.06 | 0.25 | 0.25 | 0.25 |
| Breaking elongation | | % | 30 | 30 | 27 | 27 | 27 |
| Shrinkage factor | | % | 0.3 | 0.8 | 2.2 | 2.2 | 2.1 |
| Spinning stability | | Package | Very | Very | Very | Poor | poor |
| | | tightening | good | good | good | | |
| | | Yarn | Very | Very | Good | Good | Good |
| | | breakage, | good | good | | | |
| | | fluff | | | | | |
| Package density | | g/cm³ | 0.98 | 0.98 | 1.12 | 1.12 | 1.11 |
| Developed crimp | | % | 122 | 121 | 266 | 264 | 262 |
| elongation | | | | | | | |
| Crimp elongation after | | % | 15 | 15 | 42 | 42 | 42 |
| dry heat treatment | | | | | | | |
| Reeling tension value | | | 42 | 55 | 88 | 120 | 242 |
| Dry heat | Extreme | cN/dtex | 195 | 195 | 155 | 155 | 157 |
| shrinkage | temperature | | | | | | |
| | Extreme | cN/dtex | 0.13 | 0.13 | 0.25 | 0.25 | 0.24 |
| | stress | | | | | | |

| | | | | | |
|---|---|---|---|---|---|
| Dyeing quality | Very | Very | Good | Poor | Poor |
| | good | good | | | |
| Fabric stretch | Very | Very | Very | Poor | Poor |
| property | good | good | good | | |
| Overall evaluation | Very | Very | Good | Poor | Poor |
| | good | good | | | |

TABLE 7

| | | | Example | Example | Example | Comp. |
|---|---|---|---|---|---|---|
| | | | 15 | 16 | 17 | Ex. 12 |
| High intrinsic | | dl/g | 1.2 | 1.2 | 0.9 | 0.9 |
| viscosity component | | | | | | |
| Low intrinsic | | dl/g | 0.7 | 1.1 | 0.7 | 0.9 |
| viscosity component | | | | | | |
| First roll speed | | m/min | 2500 | 2500 | 2500 | 2500 |
| Second roll speed | | m/min | 3220 | 3250 | 3450 | 3560 |
| Third roll speed | | m/min | 3220 | 3250 | 3450 | 3560 |
| Take-up speed | | m/min | 3150 | 3100 | 3350 | 3500 |
| Stretch factor | | | 1.29 | 1.30 | 1.38 | 1.42 |
| Tension ratio | | | 1.00 | 1.00 | 1.00 | 1.00 |
| Ti-To | | cN/dtex | 0.03 | 0.03 | 0.03 | 0.03 |
| Ti | | cN/dtex | 0.06 | 0.07 | 0.06 | 0.08 |
| Breaking elongation | | % | 30 | 32 | 30 | 28 |
| Shrinkage factor | | % | 0.6 | 0.7 | 0.8 | 0.8 |
| Spinning stability | | Package | Very | Very | Very | Very |
| | | tightening | good | good | good | good |
| | | Yarn | Very | Good | Very | Good |
| | | breakage, | good | | good | |
| | | fluff | | | | |
| Developed crimp | | % | 111 | 34 | 123 | 0 |
| elongation | | | | | | |
| Crimp elongation after | | % | 12 | 3 | 16 | 1 |
| dry heat treatment | | | | | | |
| Package density | | g/cm³ | 0.97 | 0.98 | 0.98 | 0.99 |
| Reeling tension value | | | 13 | 52 | 46 | 68 |
| Dry heat | Extreme | cN/dtex | 180 | 191 | 195 | 210 |
| shrinkage | temperature | | | | | |
| | Extreme | cN/dtex | 0.25 | 0.15 | 0.13 | 0.09 |
| | stress | | | | | |

| | | | | |
|---|---|---|---|---|
| Dyeing quality | Very | Very | Very | Good |
| | good | good | good | |
| Fabric stretch | Very | Good | Very | Poor |
| property | good | | good | |
| Overall evaluation | Very | Good | Very | Poor |
| | good | | good | |

TABLE 8

| | | Example | Example | Example |
|---|---|---|---|---|
| | | 2 | 18 | 19 |
| Traverse angle at | Degrees | 4.0 | 8.8 | 2.0 |
| wound thickness of | | | | |
| 0-1 mm | | | | |
| Traverse angle at | Degrees | 8.8 | 8.8 | 8.8 |
| wound thickness of | | | | |
| 40-60 mm | | | | |
| Traverse angle at | Degrees | 6.0 | 6.0 | 6.0 |
| wound thickness of | | | | |
| 100-120 mm | | | | |
| Reeling tension | | 46 | 82 | 76 |
| value | | | | |

1. A highly crimped conjugate fiber cheese package which is obtained by layering on a paper bobbin a conjugate fiber consisting of a plurality of single filament composed of polytrimethylene terephthalate components having different intrinsic viscosities and consisting of at least 90 mol % of a trimethylene terephthalate unit and no more than 10 mol % of another ester repeating unit and laminated to each other in a side-by-side type, the cheese package being characterized by satisfying the following conditions (1)-(4).
1) The single filament composing the conjugate fiber has cross-sectional shape which is flat cross-section with a flatness of 1.1-3 as the ratio between the long axis and short axis.
2) The developed crimp elongation of the conjugate fiber is 30-200%.
3) The relationship between the contact area (compressed net area) S (cm²) between the paper bobbin and conjugate fiber and the wound weight W (kg) satisfies the following formula (1):
2≦W≦0.02S (Formula 1)
where 240≦S≦1000
(4) The package density of the conjugate fiber cheese package is 0.92-1.05 g/cm³.

2. A highly crimped conjugate fiber cheese package according to claim 1, characterized in that the crimp elongation of the conjugate fiber is 4-30% after dry heat treatment for 30 minutes at 90° C. under a load of 0.9×10⁻² cN/dtex.

3. A highly crimped conjugate fiber cheese package according to claim 1, characterized in that the crimp elongation of the conjugate fiber is 8-30% after dry heat treatment for 30 minutes at 90° C. under a load of 0.9×10² cN/dtex.

4. A highly crimped conjugate fiber cheese package according to any one of claims 1, 2 and 3, characterized in that the value for the reeling tension value (package performance factor, PDF) of the conjugate fiber layered to a thickness of about 1 mm in the most inner core is 0-100, as measured after heat treatment of the cheese package at 45° C. for 24 hours.

5. A highly crimped conjugate fiber cheese package according to any one of claims 1 to 4, characterized in that the percentage reduction d(%) is 0-30%, as measured after heat treatment of the cheese package at 45° C. for 24 hours and calculated by the following formula (2) from the finishing agent deposit efficiency (a) on 1 g of the most inner core fiber and the finishing agent deposit efficiency (b) on the conjugate fiber layered on the surface section.
d=(b−a)/b×100 (Formula 2)

6. A highly crimped conjugate fiber cheese package according to any one of claims 1 to 5, characterized in that the paper bobbin used is a waterproofed-oilproofed paper bobbin with a water absorption of no greater than 40 g/m²·15 min as measured on the take-up paper bobbin surface according to JIS-P-8140:1988.

7. A highly crimped conjugate fiber cheese package according to any one of claims 1 to 6, characterized in that the contact area (compressed net area) S between the paper bobbin and conjugate fiber is 300-800 (cm²), and the wound weight W is 3-20 (kg).

8. A highly crimped conjugate fiber cheese package according to any one of claims 1 to 7, characterized in that the package density of the conjugate fiber cheese package is 0.93-1.03 g/cm³.

9. A process for production of a highly crimped conjugate fiber cheese package wherein after melt spinning of a conjugate fiber consisting of a plurality of single filament composed of polytrimethylene terephthalate components having different intrinsic viscosities and consisting of at least 90 mol % of a trimethylene terephthalate unit and no more than 10 mol % of another ester repeating unit and laminated to each other in a side-by-side type, and cooling solidification with cooling air to form single filament having flat cross-section with a flatness of 1.1-3, at least three heating rolls are used for direct spin-drawing/heat treatment and the conjugate fiber is taken up onto a paper bobbin at a take-up speed of 2000-5000 m/min to form a cheese package with a wound weight of 2 kg or greater, characterized in that the following conditions (A)-(D) are satisfied.
(A) Drawing is to a breaking elongation of 25-40%.
(B) The conjugate fiber is heat treated with a suitable combination of temperature and tension ratio at the final heating roll until the shrinkage factor of the conjugate fiber measured immediately after take-up is 0.3-1.0%.
(C) The flat compressive strength of the paper bobbin is 1000-7000 N.
(D) Take-up is with a contact area (compressed net area) S (cm²) of 240-1200 cm² between the paper bobbin and conjugate fiber.

10. A process for production of a highly crimped conjugate fiber cheese package according to claim 9, characterized in that the tension To at the final heating roll exit point and the tension Ti at the traverse guide entrance point (winding tension) during take-up of the cheese package are controlled to within the ranges specified by the following formulas (3) and (4).
0≦Ti−To≦0.05 (cN/dtex) (Formula 3)
0.05<Ti≦0.20 (cN/dtex) (Formula 4)

11. A process for production of a highly crimped conjugate fiber cheese package according to claim 9 or 10, characterized in that during take-up of the conjugate fiber, the traverse angle at a take-up thickness of 1 mm is no greater than half the maximum traverse angle during take-up of the package.

12. A highly crimped conjugate fiber cheese package according to any one of claims 1 to 8, wherein the package is obtained by layering on a paper bobbin a highly crimped conjugate fiber, the conjugate fiber satisfying the following conditions (1), (2), (5) and (6).
1) The single filament cross-sectional shape in the conjugate fiber is flat cross-section with a flatness of 1.1-3 as the ratio between the long axis and short axis.
2) The developed crimp elongation of the conjugate fiber is 30-200%.
5) The crimp elongation of the conjugate fiber is 4-30% after dry heat treatment for 30 minutes at 90° C. under tension of 0.9×10⁻² cN/dtex.
6) The extreme temperature for dry heat shrinkage stress of the conjugate fiber is 195-225° C., and the extreme stress is 0.05-0.20 cN/dtex.
